(19) United States
(12) Patent Application Publication
(10) Pub. No.: US 2005/0044276 A1
(43) Pub. Date: Feb. 24, 2005

(54) Asynchronous data receiver comprising means for standyby mode switchover

(75) Inventors: Ludovic Ruat, Savourin (FR); Paul Kinowski, Aix-en-Provence (FR); Alexander Czajor, Bouc Bel Air (FR)

Correspondence Address: SEED INTELLECTUAL PROPERTY LAW GROUP PLLC, 701 FIFTH AVENUE, SUITE 6300, SEATTLE, WA, 98104-7092, US

(73) Assignee: STMicroelectronics sa, Montrouge (FR)

(21) Appl. No.: 10/493,039

(22) PCT Filed: Oct. 11, 2002
(86) PCT No.: PCT/FR02/03479

(30) Foreign Application Priority Data
Oct. 15, 2001 (FR) 01/13274

(51) Int. Cl. G06F 3/00

(52) U.S. Cl. 710/1

(57) ABSTRACT

A device for receiving asynchronous frames beginning with a header field, the device including a circuit for switching into a stand-by mode, a circuit for recognizing a header field, and a circuit for leaving the stand-by mode when a valid header field is recognized, the stand-by mode including the filtering of at least one signal likely to be emitted by the receiver device during the reception of a header field. The device is suitable in particular for UART circuits that are present in microcontrollers.

### BACKGROUND OF THE INVENTION

1. Field of the Invention

The present invention relates to the field of devices for transmitting asynchronous data, generally called “UARTs” (Universal Asynchronous Receiver Transceiver) and, more particularly, to the stand-by setting and the activation of an asynchronous data receiver.

2. Description of the Related Art

Asynchronous data are generally transmitted by means of asynchronous frames comprising one or more standard characters. Such standard characters generally comprise 10 bits, among which there are 8 data bits preceded by a start bit and followed with a stop bit. Contrary to synchronous data transmissions, the receiver does not receive the clock signal from the emitter, so that the respective clocks of the emitter and the receiver must have, the one in relation to the other, a deviation which does not exceed a certain value in order that the data can be correctly transmitted.

To aid in better understanding, FIG. 1 shows the format of an asynchronous frame according to protocol LIN (“Local Interconnect Network”). This frame first comprises a break character BRK comprising a predetermined number of bits at 0 and a last bit equal to 1 (“extra bit”), then a synchronization character SYNC, and then data characters CH1, CH2 . . . CHN. Character CH1 can be used as an identification field to allow multipoint links between a master device and slave devices.

Character SYNC is represented with more details in FIG. 2 and is equal to [55]h in hexadecimal notation, that is character “10101010” in binary notation (bits B0 to B7). This synchronization character being preceded by a start bit STB at 0 and followed with a stop bit SPB at 1, one has in total at one's disposal 5 falling edges for matching a local clock signal to the reference clock signal of character SYNC. The duration between the 5 falling edges being equal to 8 times the period T of the reference clock signal. The measure of this duration allows the reference period T to be determined and the period of the local clock signal to be matched to it.

The first data character CH1 is an identification character which defines the attributes of the message formed by the data characters CH2, . . . CHN. The four first bits of this identification character contain the identification of the addressee of the message, the two following bits indicate the length of the message, and the two last bits are parity bits.

The combination of the break character BRK, the synchronization character SYNC, and the identification character CH1 constitutes the header field of a LIN frame.

FIG. 3 schematically shows the architecture of a circuit UART provided for receiving such asynchronous frames.

A local clock signal CK is delivered by a divider DIV1, generally a divider by 16, receiving a sampling signal CKS as an input. Signal CKS is itself delivered by a programmable divider DIV2 receiving a primary clock signal CK0 as an input. The ratio between the frequency of signal CK0 and the frequency of signal CKS is determined by a value DVAL loaded in a register DREG of the programmable divider.

Circuit UART further comprises a buffer circuit BUFC and a state machine SM which identifies the break BRK and synchronization SYNC characters, and delivers information signals IS to the outside environment. It will be considered in the following, by way of a non limiting example, that the “outside environment” is the central processing unit of a microcontroller (not shown) in which circuit UART is arranged. Signals IS indicate for example that a character SYNC is being received, that a received data is available for read in circuit BUFC, etc.

Buffer circuit BUFC comprises here two reception registers SREG1, SREG2, an emission register SREG3, a 4 bits counter CT1 (counter by 16), two logic comparators CP1, CP2 and a circuit AVCC. Register SREG1 is a shift register of 10 bits, the input SHIFT of which is clocked by signal CKS. It receives data RDT on a serial input SIN connected to a data reception terminal RPD, and delivers sampled data SRDT (bits b0 to b9) on a parallel output POUT. The data SRDT are applied to the input of circuit AVCC, the output of which delivers a bit Bi which is sent to a serial input SIN of register SREG2. Each bit Bi delivered by circuit AVCC is conventionally equal to the majority value of the samples of rank 7, 8 and 9 (bits b7 to b9) present in register SREG1.

The data SRDT are also applied to an input of comparator CP1, the other input of which receives a reference number “1110000000”, forming a falling edge detection criteria. Comparator CP1 delivers a signal FEDET which is communicated to the outside environment and which is also applied to a resetting to 6 input (input “SET 6”) of counter CT1, which is clocked by signal CKS. Counter CT1 delivers a sample counting signal SCOUNT which is applied to an input of comparator CP2, the other input of which receives, in a binary form, a reference number equal to 9 in base 10. The output of comparator CP2 drivers the shift input SHIFT of register SREG2. Lastly, register SREG3 is a shift register clocked by local clock signal CK, receiving data XDT on a parallel input PIN and delivering serial data XDT on an output SOUT connected to a terminal XPD.

After the reception of character SYNC, the data present in characters CH1, CH2 . . . are received bit by bit, a data bit Bi delivered by circuit AVCC (majority value of samples b7 to b9) being loaded into register SREG2 every 16 cycles of signal CKS, that is every cycle of local clock signal CK. The loading of a bit Bi is performed at the tenth counting cycle of counter CT1, when the output of comparator CP2 passes to 1. The received data RDT are stored in register SREG2 by groups of 8 bits B0-B7 and can be read by means of a parallel output POUT of this register.

Character SYNC represented in FIG. 2 allows circuit UART to determine the value DVAL to be placed into divider DIV2 for obtaining a small deviation of the local clock signal CK. This value is such that the period Ts of the sampling signal CKS must be equal to
Ts=D/(8*16)
D being the duration measured between the five falling edges of the synchronization character, that is eight periods T of the reference clock. The calculation of DVAL may be ensured by a particular wired logic circuit (not shown) associated to state machine SM, or by a microcontroller's central processing unit.

It appears in practice that circuit UART delivers to the outside environment various signals and various data when a message is being received, and that the outside environment performs various operations, in particular reading operations, which are not useful if the message is not intended to it.

### BRIEF SUMMARY OF THE INVENTION

The disclosed embodiments of the present invention release the outside environment from useless tasks, avoiding characters that are not intended to it.

To that effect, the disclosed embodiments of the present invention provide a device for receiving asynchronous frames beginning with a header field, which includes means for switching into a stand-by mode, the stand-by mode including the filtering of at least one signal likely to be emitted by the receiver device during the reception of a header field, means for recognizing a header field, and means for leaving the stand-by mode when a valid header field is recognized.

According to an embodiment, the means for recognizing a header field are arranged to recognize a valid header field when the header field comprises a break character formed of bits having all the same value.

According to an embodiment, the means for recognizing a header field are arranged to recognize a valid header field when the header field comprises a synchronization character.

According to an embodiment, the means for recognizing a header field are arranged to recognize a valid header field when the header field comprises an identification character.

According to an embodiment, the means for recognizing a header field are arranged to recognize a valid header field when the header field comprises an identification character corresponding to an identity of the device.

According to an embodiment, the stand-by mode is controlled by a flag which can be forced to a predetermined value from the outside of the device.

According to an embodiment, the means for recognizing a header field and the means for leaving the stand-by mode when a valid header field is recognized comprise a state machine.

The present invention also relates to an integrated circuit comprising a device according to the invention.

The present invention also relates to a microcontroller comprising a device according to the invention.

The disclosed embodiments of the present invention also relate to a method of receiving asynchronous frames beginning with a header field, implemented by means of a frame receiver device comprising a stand-by mode controlled by a predetermined means, the stand-by mode comprising the filtering of at least one signal likely to be emitted by the receiver device during the reception of a header field, and comprising a step of recognizing a header field and an action on the means for controlling the stand-by mode when a header field is recognized, so as to let the receiver device leave the stand-by mode if this one is in the stand-by mode.

According to an embodiment, the means for controlling the stand-by mode comprises a flag and the action on the means for controlling the stand-by mode comprises the fact to force the flag to a predetermined value.

According to an embodiment, a header field is recognized as being valid when it comprises a break character formed of bits having all the same value.

According to an embodiment, a header field is recognized as being valid when it comprises a synchronization character.

According to an embodiment, a header field is recognized as being valid when it comprises an identification character.

According to an embodiment, a header field is recognized as being valid when it comprises an identification character which corresponds to an identity of the device.

According to an embodiment, the steps of recognizing a header field and the action on the means for controlling the stand-by mode when a header field is recognized, are performed by means of a state machine.

In accordance with another embodiment of the invention, a microcontroller is provided. The microcontroller includes a memory circuit; a controller coupled to the memory circuit; a uniform asynchronous receiver-transceiver device coupled to the controller and to an input and an output of thee microcontroller. The device includes a state machine configured to send a data-received signal to the controller when the device receives data that is available for reading by the controller, the state machine configured to filter the data-received signal when in a stand-by mode; a circuit for recognizing reception of a header field; and a circuit for leaving the stand-by mode when a valid header field is recognized.

### BRIEF DESCRIPTION OF THE SEVERAL VIEWS OF THE DRAWINGS

These characteristics and advantages as well as others of the present invention will be described with more details in the following description of an example of embodiment of a device UART according to the invention, done in a non limiting way, in conjunction with the accompanying drawings in which:

FIG. 1, previously described, shows an asynchronous frame according to protocol LIN,

FIG. 2, previously described, shows a synchronization character,

FIG. 3, previously described, shows a conventional circuit UART,

FIG. 4 shows a microcontroller comprising a circuit UART1 according to the present invention, and

FIG. 5 shows a state machine according to the present invention in the circuit UART1 of FIG. 4.

### DETAILED DESCRIPTION OF THE INVENTION

FIG. 4 schematically shows a microcontroller MC comprising, on a same silicon chip, a central processing unit UC, a program memory MEM, and a circuit UART1 according to the invention. The circuit UART1 is connected to input/output pads RPD/XPD of the integrated circuit.

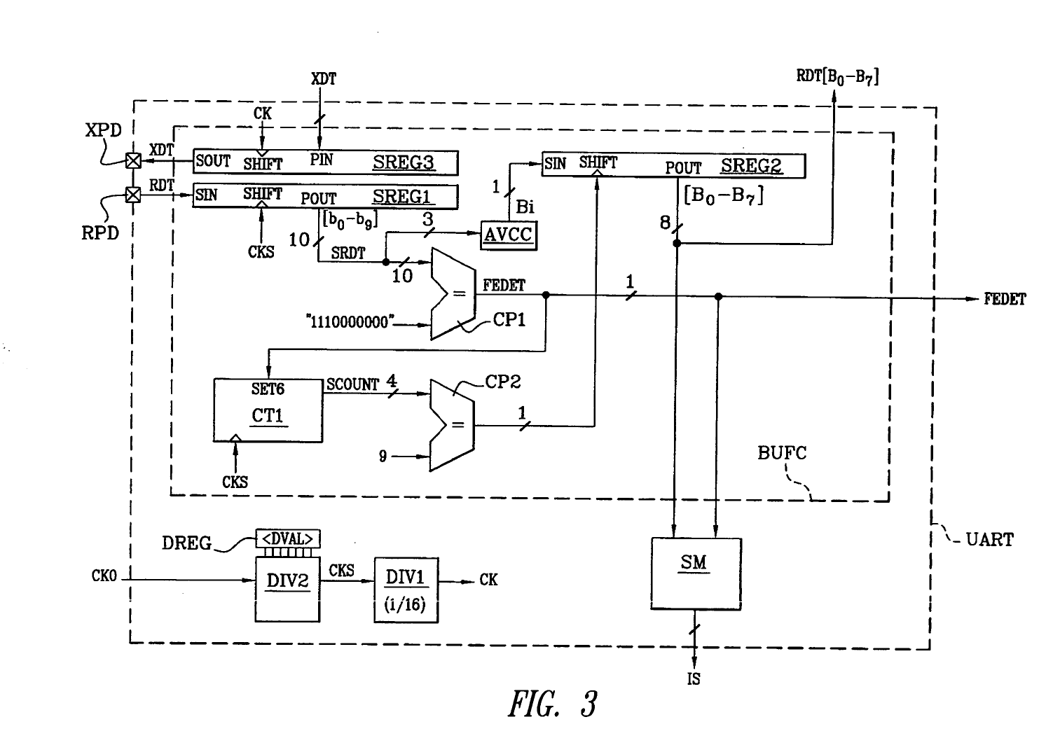

The overall architecture of circuit UART1 corresponds to the one of the conventional UART circuit described in the preamble in relation with FIG. 3, and will not be again described. The central processing unit UC uses circuit UART1 for emitting and receiving asynchronous data via pads XPD, RPD. Circuit UART1 sends, to the central processing unit, a signal DRC (“Data Received”) when data RDT are received and are available for reading in its reception register (register SREG2, FIG. 3), the signal DRC being for example applied to an interruption decoder of the central processing unit. Signal DRC is one of the information signals IS delivered by circuit UART1 towards the outside environment (signal DRC only being shown in FIG. 4).

Circuit UART1 distinguishes from conventional circuit UART by the fact that it comprises a state machine SM1 provided for managing a stand-by mode in which signal DRC at least is not emitted. The stand-by mode is here controlled by a stand-by setting flag WU equal for example to 1 in the stand-by mode and to 0 in the active mode. Flag WU is stored in a predetermined register of circuit UART1, and can be forced to 1 by the central processing unit UC in order to set circuit UART1 into the stand-by mode.

Still according to the invention, circuit UART1 leaves the stand-by mode only when it has detected a valid frame beginning, in a way which will be described now in relation to protocol LIN by way of a non limiting example.

In a LIN frame of the type described in the preamble, the break character BRK consists in a series of 13 bits at 0 clocked by a reference clock signal. To take into account of an offset between this signal and the local clock signal, the detection of this character is performed by identifying at least 11 bits at 0. This number of 11 bits is chosen by convention in order to allow a clock deviation of the order of ±15%.

The state machine SM1 of circuit UART1 comprises thus a first module FWM forming a detection unit of the break character BRK.

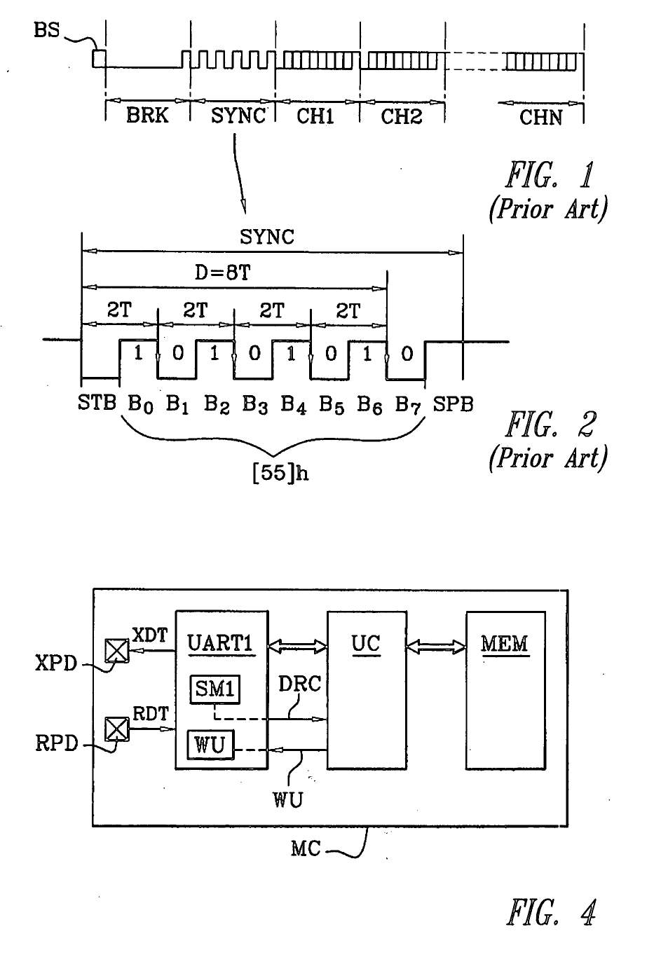

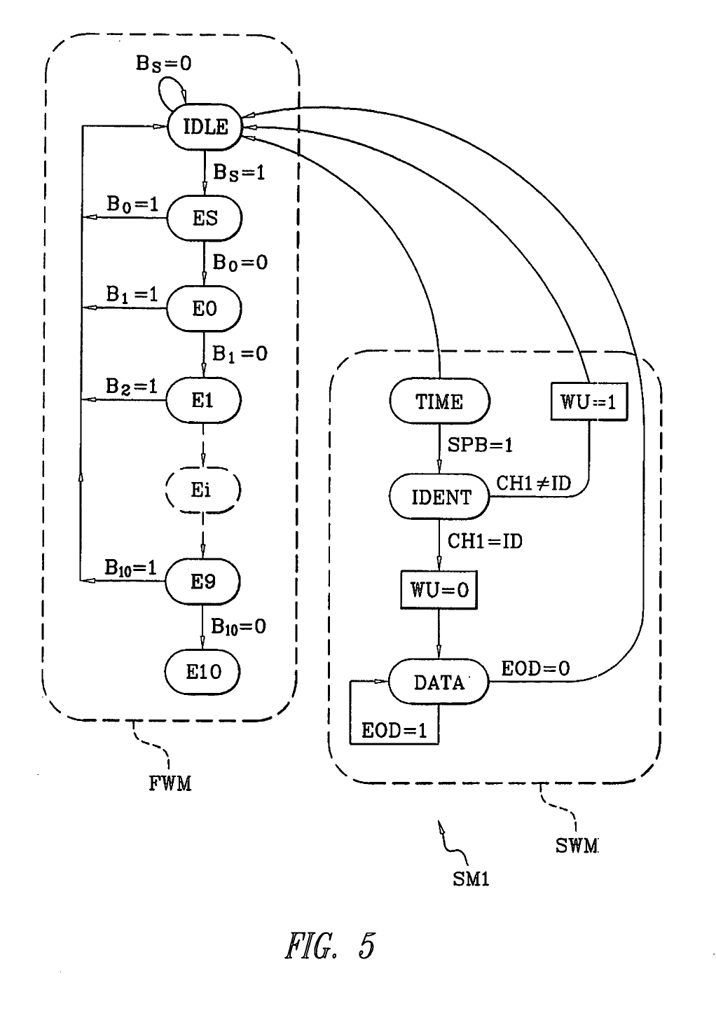

An example of embodiment of module FWM of state machine SM1 is represented in FIG. 5. The reception of a bit BS at 1 (bit BS preceding a character BRK, Cf. FIG. 1) causes the passage from a waiting state IDLE to an intermediate state ES. The reception of the following bit B0, depending on Whether it is equal to 0, respectively to 1, causes the passage to an intermediate state E0 or, respectively, the return to state IDLE. In state B0, the reception of the second bit B1 following bit BS, depending on whether it is equal to 0, respectively to 1, causes the passage to an intermediate state E1 or, respectively, the return to state IDLE.

By way of generalization, the reception, by the state machine being in an intermediate state Ei, of the (i+1)^{th} bit following bit BS causes the passage to a state Ei+1 or the return to state IDLE depending on whether the received bit is equal to 0 or 1.

When index i is equal to 9, the reception of the eleventh bit B10 following bit BS, depending on whether it is equal to 0 or 1, causes the passage to a state E10 or the return to the waiting state.

It should be noted that the break character BRK can be detected in any other way, for example by means of a shift register of 11 bits, all the bits of which are subject to a logic AND operation.

When the break character BRK is detected, the next characters of the frame are all standard characters formed of 10 bits. These standard characters are processed by means of a processing unit which is for example a second module SWM of state machine SM1.

An example of embodiment of module SWM is also represented in FIG. 5 and comprises first a state TIME in which the synchronization character SYNC is received and analyzed. As a matter of fact, the structure of the frame is such that the synchronization character SYNC follows immediately the break character BRK. The end of the synchronization character SYNC, detected by means of stop bit SPB, causes the passage to a state IDENT, while an error in the recognition of this character causes the return to the waiting state IDLE.

In state IDENT, the next character, that is the first identification character CH1, is received and analyzed. Furthermore, the value of the stand-by setting flag WU is possibly modified.

It is supposed here that the central processing unit has set circuit UART into the stand-by state (WU=1) before the reception of the frame, so that signal DRC (FIG. 4) has not been emitted during the reception of the first two characters, the stand-by setting flag WU being equal to 1.

If the identification character CH1 does not correspond to the identity ID of circuit UART1, the stand-by setting flag WU is set to 1 whatever its current value may be, and the state machine returns to the waiting state IDLE. In an alternative embodiment, the stand-by setting flag WU can be let to its current value (which may be 0 or 1 depending on the value set by the outside environment) when the state machine returns to the waiting state IDLE.

If, on the other hand, the identification character CH1 indeed corresponds to the identity ID of circuit UART1, the stand-by setting flag WU is set to 0, which corresponds to the “wake-up” of circuit UART1 in relation to the outside environment and the passage of state machine SM1 to a state “DATA”.

In state DATA, the data standard characters are processed consecutively in a known manner. When a standard character is received, signal DRC is emitted in order to cause an interruption in the central processing unit and the sending, by the latter, of the received data to a read subroutine.

The number of these characters being variable, there is provided a length indicator EOD which is equal to 1 as long as a new character must follow and equal to 0 when the currently processed character is the last of the frame. When this indicator is equal to 1, it causes the return to state DATA. On the contrary, when it is equal to 0, it causes the passage to state IDLE.

The management of the stand-by mode of some circuit being per se an operation within the skills of those skilled in the art, it does not need to be specifically developed. In the stand-by mode, circuit UART1 preferably filters all the characters which do not correspond to the wake-up sequence, that is the frame header field provided with character CH1. On the other hand, when the wake-up sequence is recognized, the central processing unit UC is informed, for example by means of an interruption caused by signal DRC.

Of course, the stand-by mode described above can be superposed to another mode of the same type which would be further provided.

The present invention is of course likely to have various alternatives and embodiments. In particular, any step or any means described above can be replaced with an equivalent step or an equivalent means within the scope and spirit of the present invention.

Furthermore, although there has been proposed above to leave the stand-by mode when the state machine SM of circuit UART1 has checked that the identification character CH1 indeed corresponds to a predefined identity ID, this checking operation can also be performed by the central processing unit. In this case, circuit UART1 leaves the stand-by mode when a valid identification character CHI is received, without checking its content, and emits signal DRC. After reception of signal DRC, reading of character CH1 in circuit UART1 (register SREG2, FIG. 3) and checking of character CH1, the central processing unit UC forces again circuit UART1 into the stand-by mode, setting flag WU to 11 if character CH1 does not correspond to identity ID, and otherwise waits for the next signal DRC for reading the next character CH2.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A device (UART1) for receiving asynchronous frames beginning with a header field, comprising:
means for switching into a stand-by mode, the stand-by mode comprising the filtering of at least one signal likely to be emitted by the receiver device during the reception of a header field,
means for recognizing the header field, and
means for leaving the stand-by mode when a valid header field is recognized.

2. The device of claim 1, wherein the means for recognizing a header field are arranged to recognize a valid header field when the header field comprises a break character formed of bits having all the same value.

3. The device of claim 1, wherein the means for recognizing a header field are arranged to recognize a valid header field when the header field comprises a synchronization.

4. The device of claim 1, wherein the means for recognizing a header field are arranged to recognize a valid header field when the header field comprises an identification characters.

5. The device of claim 1 wherein the means for recognizing a header field are arranged to recognize a valid header field when the header field comprises an identification character corresponding to an identity of the device.

6. The device of claim 1, wherein the stand-by mode is controlled by a flag that can be forced to a predetermined value from outside of the device.

7. The device of claim 1, wherein the means for recognizing a header field and the means for leaving the stand-by mode when a valid header field is recognized comprise a state machine.

8. An integrated circuit, comprising a device according to claim 1.

9. A microcontroller, comprising a device according to claim 1.

10. A method of receiving asynchronous frames beginning with a header field, the method implemented by means of a frame receiver device having a stand-by mode controlled by a predetermined means, the stand-by mode involving the filtering of at least one signal likely to be emitted by the receiver device during the reception of a header field, the method comprising: a step of recognizing a header field and of an action on the means for controlling the stand-by mode when a header field is recognized, so as to let the receiver device leave the stand-by mode when it is in the stand-by mode.

11. The method of claim 10, wherein the means for controlling the stand-by mode comprise a flag and the action on the means for controlling the stand-by mode comprises forcing the flag to a predetermined value.

12. The method of claim 10, wherein a header field is recognized as valid when it comprises a break character formed of bits having all the same value.

13. The method of claim 10, wherein a header field is recognized as valid when it comprises a synchronization character.

14. The method of claim 10, wherein a header field is recognized as valid when it comprises an identification character.

15. The method of claim 10, wherein a header field is recognized as being when it comprises an identification character that corresponds to an identity of the device.

16. The method of claim 10 wherein the steps of recognizing a header field and of the action on the means for controlling the stand-by mode when a header field is recognized are performed by means of a state machine.

17. A device for receiving asynchronous frames beginning with a header field, the device comprising:
a circuit for switching into a stand-by mode during reception of a header field, the stand-by mode structured to filter at least one signal to be emitted by the device during the reception of the header field;
a circuit for recognizing the header field; and
a circuit for leaving the stand-by mode when a valid header field is recognized.

18. A device for receiving asynchronous frames that include a header field, the device comprising:
a state machine comprising a circuit for recognizing a header field received by the device, a circuit for switching into a stand-by mode for filtering of at least one signal likely to be emitted by the device during the reception of the header field, and a circuit for leaving the stand-by mode when a valid header field is recognized.

19. An integrated microcontroller, comprising:
a memory circuit;
a controller coupled to the memory circuit;
a uniform asynchronous receiver-transceiver device coupled to the controller and to an input and an output of the microcontroller, the device comprising:
a state machine configured to send a data-received signal to the controller when the device receives data that is available for reading by the controller, the state machine configured to filter the data-received signal when in a stand-by mode;
a circuit for recognizing reception of a header field; and
a circuit for sending a control signal to the state machine to enter the stand-by mode when a valid header field is not recognized and to leave the stand-by mode when a valid header field is recognized.

20. The microcontroller of claim 19, wherein the state machine is configured to not filter the data-received signal when the circuit for leaving the stand-by mode recognizes a valid header field.

21. The circuit of claim 20, wherein the device further comprises a register for storing a flag having a predetermined value to initiate the stand-by mode.

22. The circuit of claim 21, wherein the controller is configured to force the flag to initiate the stand-by mode of the device.

23. The microcontroller of claim 22 wherein the device is configured to detect an error in recognizing the header field and to cause the device to remain in the stand-by mode.
